(19) United States
(12) Patent Application Publication
(10) Pub. No.: US 2009/0280674 A1
(43) Pub. Date: Nov. 12, 2009

(54) HDMI CONNECTION SYSTEM AND METHOD FOR USE

(76) Inventors: Anthony Eppright, Lakewood, WA (US); Hiroko Suga, Lakewood, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/115,859

(22) Filed: May 6, 2008

(51) Int. Cl. H01R 13/64

(52) U.S. Cl. 439/373

(57) ABSTRACT

The current invention is a method and apparatus to secure and HDMI cable to an electronic system.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

High Definition Multimedia Interface (“HDMI”) is an uncompressed, all digital audio-visual (“A/V”) interface. The HDMI dramatically simplifies cabling and provides a high quality home experience. HDMI provides an interface between any digital A/V source such as a set-top box, DVD player, satellite receiver, or other A/V source and an A/V receiver/controller or display device, such as a digital television (DTV), or DTV projector, among others.

HDMI is a digital interface consequently, it provides the best quality of video since there are no lossy analog to digital conversions as are required for analog connection. The difference is especially noticeable at higher resolution such as 1080 p. D/V will be sharper than component, and eliminates the softness and ghosting found with component. Small, high contrast details such as text brings this difference out most.

Also, HDMI supports two way communications between the video source (e.g. a DVD player) and the DTV allowing functionality such as automatic configuration and one-touch play. When using the HDMI, devices automatically deliver the most effective format (e.g. 480 p v. 720 p, 16:9 v. 4:3) for the display that it is connected to, eliminating the need for the user to scroll through format options to look at what looks best.

HDMI cables can use standard copper or other metal construction allowing for long cables lengths. Cables up to 10 meters have passed the “Standard Cable” HDMI compliance test. Additionally, there are many adapters, that work on HDMI, that extend a cable's effective distance from the typical 10 m length to much longer lengths.

Although HDMI technology greatly improves the users A/V experience, there are serious consequences when the connection between HDMI and the A/V device is not secure. If the HDMI connection is not secured properly with the A/V component, the connection is loose or is loosened over time causing the signal to be lost. Even if the HDMI connection is secured properly, repetitive plugging and unplugging of the HDMI connection is known to cause added stress to the input or permanently loosening the connection possibly causing damaging the component's input. This problem can be caused by the slightest movement of a component, weight of the cable, or weight of adjacent cables connecting various components, among others. This problem can be amplified by longer cable lengths supported by HDMI technology.

Longer cables, allowed by HDMI technology, naturally allows more movement in the connection; the longer the cable, the more likely it will be kicked, twisted, or jerked causing loosening the HDMI contact. Additionally, the increased weight of the HDMI cables, due to increased lengths, will naturally cause a downward gravitational pull on the HDMI connection.

Information relevant to attempts to address these problems can be found in the following US patents: U.S. Pat. No. 7,903 (Nov. 28, 2006) discloses an electrical plug restricting apparatus used to restrict electrical equipment to the chassis of electrical equipment. U.S. Pat. No. 6,939,161 (Sep. 6, 2005) discloses a cable connector which is configured to connect to a device. The cable connector further includes a retaining clip configured to which secures the cable connector to the device. U.S. Pat. No. 6,683,258 (Jan. 27, 2004) discloses a bracket that secures a cable in a static position. U.S. Pat. No. 6,520,792 (February 2003) discloses device to tightly secure various size plugs to a socket for use in an electrical device. U.S. Pat. No. 5,575,677 (Nov. 19, 1996) discloses a power plug retainer which is essentially a parallelepiped box having an open side and an open end. U.S. Pat. No. 5,324,209 (Jun. 28, 1994) discloses a connector shell assembly that retains both a conventional connector and a strain relief or radio jack. U.S. Pat. No. 5,044,976 (Sep. 3, 1991) discloses an electrical cord holder which can be secured to a conventional electrical outlet. A clamp is detachably secured around the electrical cord immediately adjacent the plug while the plug is inserted within the wall outlet. However, these references do not solve the problems introduced by HDMI technology. The aforementioned references describe a one-to-one relationship between a particular cable connection to a particular device; there is not one system that supports HDMI cables to all electronic devices. The current invention is a method and apparatus to secure and HDMI cable to any wall-plate, adapter, or other electronic device.

### BRIEF SUMMARY OF THE INVENTION

The current invention is a method and apparatus to secure a HDMI cable to an electronic device, wall-plate, adaptor, or other device.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a side elevation view of the HDMI Connection System;

FIG. 2 is a back view of the HDMI Connection System;

FIG. 3 is a side view of the HDMI Connection System.

### DETAILED DESCRIPTION OF THE INVENTION

The HDMI Connection System is described more fully hereinafter with reference to the accompanying drawings, in which preferred embodiments of the invention are shown. This invention may, however, be embodied in many different forms and should not be construed as limited to the embodiments set for herein; rather, these embodiments are provided so that this disclosure will be thorough and complete and will fully convey the scope of the invention to those skilled in the art

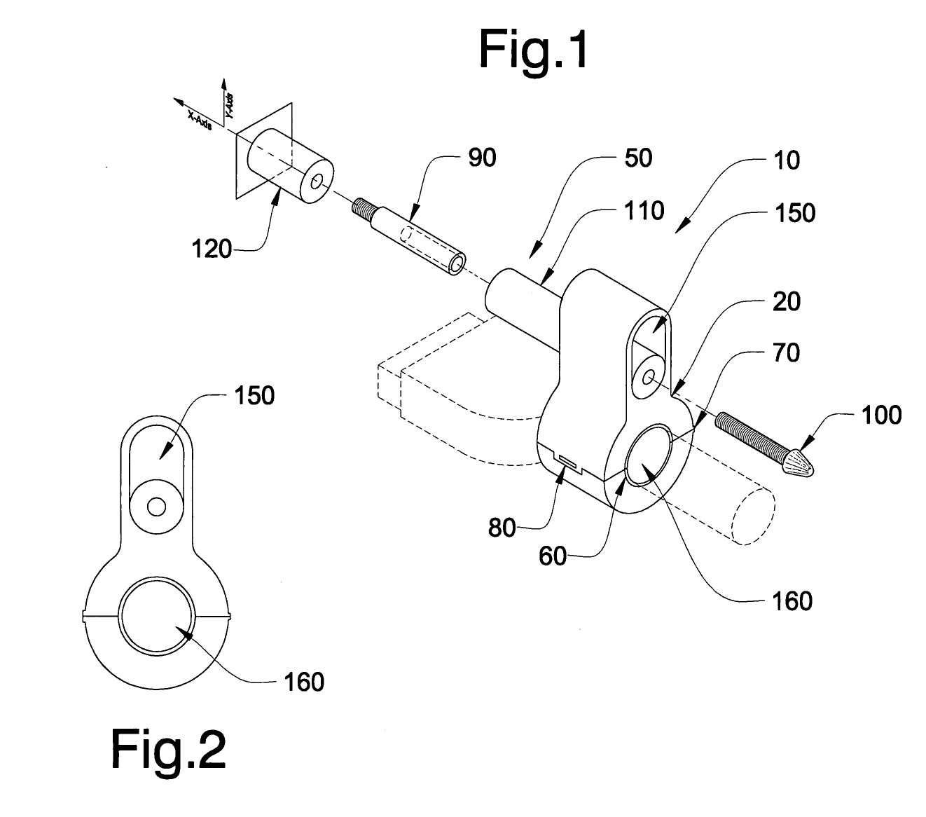

Referring to FIG. 1, The HDMI Connection System 10 comprises a main adapter 20. The main adapter 20 comprises: a standoff insert 50; a rubber insert 60; a hinge 70; and a clasp 80. The standoff insert 50 comprises: an adapter 120, the adapter comprising a means to attach the inventive system to the chassis using adhesive, known or unknown, Velcro™ or hook and loop systems, or at least one magnet, among others; a standoff screw 90; a thumbscrew 100; and a stabilizing insert sleeve 110. The adapter is used when the chassis does not have the ability to accept a screw.

Referring to FIGS. 1 and 2, the HDMI Connection System 10 defines two holes 150, 160. The HDMI Connection System 10 can rotate 360° about the x-axis so that either hole 150,160 can be positioned anywhere along the x-axis.

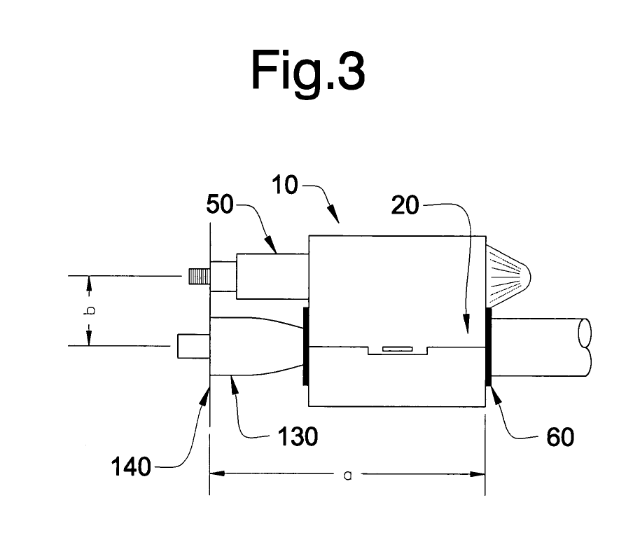

Referring to FIG. 3, in a preferred embodiment the HDMI Connection System 10 has a means to adjust the distance between chassis 140 and the rubber insert 60 (length a) to accommodate different HDMI cable lead depths. Also, in a preferred embodiment, the HDMI Connection System 10 has a means to adjust the distance between the standoff insert 50 and the HDMI cable 130 (length b) to accommodate various types of chassis and HDMI cable lengths and thickness and/or accommodate the user's judgment as to a secure location.

In one preferred embodiment, a method to use the HDMI Connection System 10 comprises: placing the HDMI cable 130 into the HDMI Connection System 10; adjusting the location of holes 150,160; closing the clasp 80; adjusting length a; adjusting length b; securing the standoff insert 90 to the chassis 140; secure the HDMI Connection System 10 to the standoff insert 90 with thumbscrew 100; and securing the HDMI cable 130 to the chassis of the electronic system.

What is claimed:

1. An HDMI Connection System comprising a main adaptor;

2. the main adapter of claim 1 defines two holes;

3. the HDMI Connection System of claim 2 has a means to rotate 360° around the x-axis;

4. the main adapter of claim 3 comprises:
a. a rubber insert;
b. a hinge
c. a clasp
d. a stand off insert

5. the standoff insert of claim 4 comprises:
a. an adapter, the adapter comprising a means to attach the inventive system to the a chassis using adhesive, known or unknown, Velcro or other hook and loop systems, and/or at least one magnet, among others;
b. a thumbscrew;
c. a stabilizing insert sleeve
d. a stand off screw

6. the main adapter of claim 4 has a means to adjust the distance between a chassis ready to accept an HDMI cable and the rubber insert;

7. the HDMI Connection System of claim 6 has a means to adjust the distance between the standoff insert of claim 5 and the main adapter of claim 4;

8. a method to use the HDMI Connection System comprises:
a. placing the HDMI cable into the HDMI Connection System
b. closing the clasp;
c. adjusting the distance between a chassis and the rubber insert;
d. adjusting the distance between the standoff insert and the main adapter;
e. securing the inventive system to the standoff insert with thumbscrew;
f. securing the inventive system to a chassis or an electronic system that accepts HDMI cables;
